(19) United States
(12) Patent Application Publication
(10) Pub. No.: US 2020/0257666 A1
(43) Pub. Date: Aug. 13, 2020

(54) "System, Method, and Computer Program Product for Monitoring and Improving Data Quality"

(71) Applicant: Visa International Service Association, San Francisco, CA (US)

(72) Inventors: Chiranjeet Chetia, Round Rock, TX (US); Punit Rajgarhia, San Francisco, CA (US); Hangqi Zhao, Austin, TX (US); Claudia Carolina Barcenas Cardenas, Austin, TX (US); Jianhua Huang, Cedar Park, TX (US)

(21) Appl. No.: 16/742,463

(22) Filed: Jan. 14, 2020

Related U.S. Application Data
(60) Provisional application No. 62/960,917, filed on Jan. 14, 2020.
(60) Provisional application No. 62/792,165, filed on Jan. 14, 2019.

(51) Int. Cl. G06F 16/215; G06F 40/205; G06Q 20/38

(52) U.S. Cl. CPC G06F 16/215; G06Q 20/38; G06F 40/205

(57) ABSTRACT

Provided is a computer-implemented method for monitoring and improving data quality of transaction data that may include conducting data pre-processing on transaction data associated with a plurality of payment transactions; determining feature values associated with a textual data field in each transaction record of a plurality of transaction records included in the transaction data associated with the plurality of payment transactions, wherein the feature values are used in a parsing layer of a natural language processing (NLP) model after conducting data pre-processing on the transaction data associated with the plurality of payment transactions; and determining whether the feature values associated with the textual data field satisfy one or more rules associated with the parsing layer of the NLP model. Computer-implemented methods may also include determining a data quality score for each textual data field of each transaction record of the plurality of transaction records included in the transaction data. A system and computer program product are also provided.

### CROSS REFERENCE TO RELATED APPLICATION

This application claims priority to U.S. Provisional Patent Application No. 62/960,917, filed Jan. 14, 2020 and U.S. Provisional Patent Application No. 62/792,165, filed Jan. 14, 2019, the disclosures of which are hereby incorporated by reference in their entireties.

### BACKGROUND

### 1. Field

This disclosure relates generally to systems, devices, products, apparatus, and methods that are used for determining a classification of an account, and in one particular embodiment, to a system, product, and method for determining a classification associated with dormancy of an account associated with a user.

### 2. Technical Considerations

Data quality may refer to the state of qualitative and/or quantitative pieces of information. Data may be generally considered high quality if it is fit for an intended uses in operations, decision making, and/or planning. Additionally, data may be deemed to be of high quality if the data correctly represents a real-world construct to which the data refers. Furthermore, as a number of data sources increases, the question of internal data consistency becomes significant, regardless of fitness for use for any particular external purpose. In some instances, data cleansing, including standardization, may be required in order to ensure data is of high quality.

Payment transaction processing methods may be described with regard to three levels of data to be included in a transaction message associated with a payment transaction (e.g., a credit card transaction): Level 1 data, Level 2 data, and Level 3 data (e.g., Level I, Level II, and Level III). Each level of data may be defined by the amount of data that is transmitted to an entity (e.g., a payment processing entity) to complete a payment transaction. With regard to relationships between the levels, Level 1 data may have the lowest requirement for an amount data that is included in a payment transaction and/or may have the highest associated processing costs for a payment transaction. In some instances, Level 2 and Level 3 data may include a set of additional information over what is included in Level 1 data that can be transmitted during a payment transaction. In some instances, Level 2 data and/or Level 3 data may provide more information for business accounts, commercial accounts, corporate accounts, purchasing accounts, and government cardholder accounts used in payment transactions.

In some instances, a payment transaction submitted with Level 2 data and/or Level 3 data may obtain lower interchange rates and/or provide a merchant involved in the payment transaction with a lower processing cost. Therefore, the merchant may elect to transmit Level 2 data and Level 3 data whenever possible during a payment transaction.

However, during a payment transaction a merchant may submit a transaction message where one or more data fields of the transaction message, such as one or more data fields associated with Level 2 data and/or Level 3 data, do not contain values or contain incorrect values. In such a situation, the payment transaction may contain values that do not allow for processing of the payment transaction or do not allow for processing the payment transaction in an efficient amount of time. In addition, where a transaction message does do not contain values or contains incorrect values, a database may not be able to be properly constructed.

### SUMMARY

Accordingly, systems, devices, products, apparatus, and/or methods for monitoring and improving data quality are disclosed that overcome some or all of the deficiencies identified above.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments that are illustrated in the accompanying schematic figures, in which:

FIG. 1 is a diagram of a non-limiting embodiment of an environment in which systems, devices, products, apparatus, and/or methods, described herein, may be implemented according to the principles of the present disclosure; and

FIG. 2 is a diagram of a non-limiting embodiment of components of one or more devices of FIG. 1.

### DESCRIPTION OF THE DISCLOSURE

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively send information to the second unit. As another example, a first unit may be in communication with a second unit if at least one intermediary unit (e.g., a third unit located between the first unit and the second unit) processes information received from the first unit and sends the processed information to the second unit. In some non-limiting embodiments, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions such as such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “account identifier” may include one or more types of identifiers associated with an account (e.g., a PAN associated with an account, a card number associated with an account, a payment card number associated with an account, a token associated with an account, and/or the like). In some non-limiting embodiments, an issuer may provide an account identifier (e.g., a PAN, a token, and/or the like) to a user (e.g., an account holder) that uniquely identifies one or more accounts associated with that user. The account identifier may be embodied on a payment device (e.g., a physical instrument used for conducting payment transactions, such as a payment card, a credit card, a debit card, a gift card, and/or the like) and/or may be electronic information communicated to the user that the user may use for electronic payment transactions. In some non-limiting embodiments, the account identifier may be an original account identifier, where the original account identifier was provided to a user at the creation of the account associated with the account identifier. In some non-limiting embodiments, the account identifier may be a supplemental account identifier, which may include an account identifier that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of account identifier. Account identifiers may be alphanumeric, any combination of characters and/or symbols, and/or the like.

As used herein, the term “token” may refer to an account identifier of an account that is used as a substitute or replacement for another account identifier, such as a PAN. Tokens may be associated with a PAN or other original account identifier in one or more data structures (e.g., one or more databases) such that they may be used to conduct a payment transaction without directly using an original account identifier. In some non-limiting embodiments, an original account identifier, such as a PAN, may be associated with a plurality of tokens for different individuals or purposes. In some non-limiting embodiments, tokens may be associated with a PAN or other account identifiers in one or more data structures such that they can be used to conduct a transaction without directly using the PAN or the other account identifiers. In some examples, an account identifier, such as a PAN, may be associated with a plurality of tokens for different uses or different purposes.

As used herein, the term “merchant” may refer to one or more entities (e.g., operators of retail businesses) that provide goods, services, and/or access to goods and/or services, to a user (e.g., a customer, a consumer, and/or the like) based on a transaction such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “point-of-sale (POS) device” may refer to one or more electronic devices, which may be used by a merchant to conduct a transaction (e.g., a payment transaction) and/or process a transaction. Additionally or alternatively, a POS device may include peripheral devices, card readers, scanning devices (e.g., code scanners and/or the like), Bluetooth® communication receivers, near-field communication (NFC) receivers, radio frequency identification (RFID) receivers, and/or other contactless transceivers or receivers, contact-based receivers, payment terminals, and/or the like.

As used herein, the term “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments, a POS system (e.g., a merchant POS system) may include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. In some non-limiting embodiments, a transaction service provider may include a credit card company, a debit card company, a payment network such as Visa®, MasterCard®, AmericanExpress®, or any other entity that processes transaction. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments, may be operated by or on behalf of a transaction service provider.

As used herein, the term “payment device” may refer to a payment card (e.g., a credit or debit card), a gift card, a smart card (e.g., a chip card, an integrated circuit card, and/or the like), smart media, a payroll card, a healthcare card, a wristband, a machine-readable medium containing account information, a keychain device or fob, an RFID transponder, a retailer discount or loyalty card, and/or the like. The payment device may include a volatile or a non-volatile memory to store information (e.g., an account identifier, a name of the account holder, and/or the like).

As used herein, the term “computing device” may refer to one or more electronic devices (e.g., processors, storage devices, and/or similar computer components) that are configured to directly or indirectly communicate with or over one or more networks. In some non-limiting embodiments, a computing device may include a mobile device. A mobile device may include a smartphone, a portable computer, a wearable device (e.g., watches, glasses, lenses, clothing, and/or the like), a personal digital assistant (PDA), and/or other like devices. In some non-limiting embodiments, a computing device may include a server, a desktop computer, and/or the like.

As used herein, the terms “client” and “client device” may refer to one or more computing devices that access a service made available by a server. In some non-limiting embodiments, a “client device” may refer to one or more devices that facilitate payment transactions, such as one or more POS devices used by a merchant. In some non-limiting embodiments, a client device may include a computing device configured to communicate with one or more networks and/or facilitate payment transactions such as, but not limited to, one or more desktop computers, one or more mobile devices, and/or other like devices. Moreover, a “client” may also refer to an entity, such as a merchant, that owns, utilizes, and/or operates a client device for facilitating payment transactions with a transaction service provider.

As used herein, the term “server” may refer to one or more computing devices that communicate with client devices and/or other computing devices over a communication network and/or, in some examples, facilitate communication among other computing devices and/or client devices.

As used herein, the term “system” may refer to one or more combinations of computing devices. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

In some non-limiting embodiments, systems, computer-implemented methods, and computer program products for encrypting sensitive data using a field programmable gate array (FPGA) device are disclosed. For example, in one non-limiting embodiment a system including at least one host application processor and at least one FPGA device coupled to the at least one host application processor via a communication bus, the at least one host application processor is programmed or configured to receive a transaction data record comprising transaction data associated with a payment transaction, transmit the transaction data record to the at least one FPGA device via the communication bus, and receive an encrypted transaction data record from the at least one FPGA device via the communication bus, wherein one or more data fields of the transaction data record are encrypted to generate the encrypted transaction data record.

In this way, embodiments of the present disclosure are effective at insuring that transaction messages associated with payment transactions contain values that allow for processing of the payment transaction and/or that allow for processing the payment transactions in an efficient amount of time. In addition, embodiments of the present disclosure are effective at allowing for the construction of a database based on transaction data included in the transaction messages associated with the payment transactions.

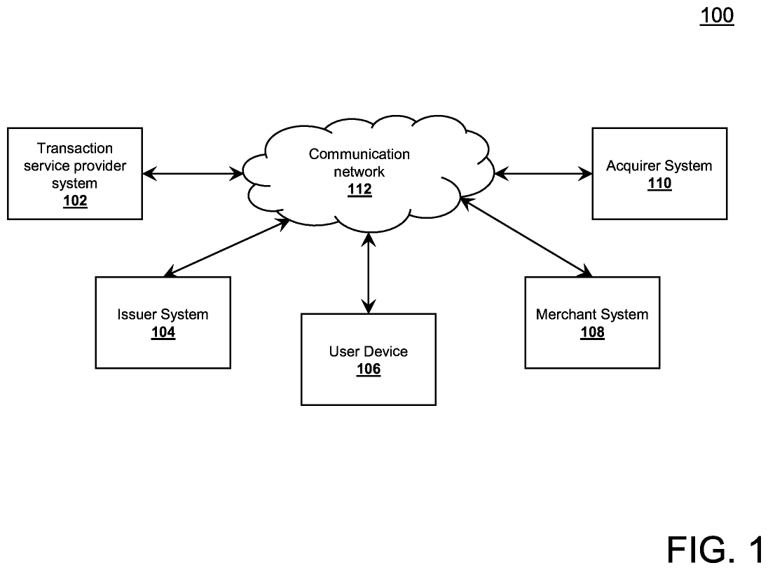

Referring now to FIG. 1, FIG. 1 is a diagram of an example environment 100 in which devices, systems, methods, and/or products described herein may be implemented. As shown in FIG. 1, environment 100 includes merchant system 108, transaction service provider system 102, acquirer system 110, issuer system 104, and user device 106. In some non-limiting embodiments, merchant system 108, transaction service provider system 102, acquirer system 110, issuer system 104, and user device 106 may interconnect (e.g., establish a connection to communicate, and/or the like) via wired connections, wireless connections, or a combination of wired and wireless connections.

Transaction service provider system 102 may include one or more devices capable of being in communication with merchant system 108, acquirer system 110, issuer system 104, and/or user device 106 via communication network 112. For example, transaction service provider system 102 may include a server (e.g., a transaction processing server), a group of servers (e.g., a group of transaction processing servers), and/or other like devices. In some non-limiting embodiments, transaction service provider system 102 may be associated with a transaction service provider, as described herein.

Issuer system 104 may include one or more devices capable of being in communication with merchant system 108, transaction service provider system 102, acquirer system 110, and/or user device 106 via communication network 112. For example, issuer system 104 may include one or more computing devices, such one or more servers, and/or other like devices. In some non-limiting embodiments, issuer system 104 may be associated with an issuer institution that issued a payment account and/or instrument (e.g., a credit account, a debit account, a credit card, a debit card, and/or the like) to a customer.

User device 106 may include one or more devices capable of being in communication with merchant system 108, transaction service provider system 102, acquirer system 110, and/or issuer system 104 via communication network 112. For example, user device 106 may include one or more computing devices, such as one or more mobile devices, one or more smartphones, one or more wearable devices, one or more servers, and/or the like. In some non-limiting embodiments, user device 106 may communicate via a short-range wireless communication connection. In some non-limiting embodiments, user device 106 may be associated with a customer as described herein.

Merchant system 108 may include one or more devices capable of being in communication with transaction service provider system 102, acquirer system 110, issuer system 104, and user device 106 via communication network 112. For example, merchant system 108 may include one or more payment devices, one or more computing devices, such as one or more mobile devices, one or more smartphones, one or more wearable devices (e.g., watches, glasses, lenses, clothing, and/or the like), one or more PDAs, one or more servers, and/or the like. In some non-limiting embodiments, merchant system 108 may communicate via a short-range wireless communication connection (e.g., a wireless communication connection for communicating information in a range between 2 to 3 centimeters to 5 to 6 meters, such as an NFC communication connection, an RFID communication connection, a Bluetooth® communication connection, and/or the like). In some non-limiting embodiments, merchant system 108 may be associated with a merchant, as described herein.

Acquirer system 110 may include one or more devices capable of being in communication with merchant system 108, transaction service provider system 102, issuer system 104, and/or user device 106 via communication network 112. For example, acquirer system 110 may include one or more computing devices, such one or more servers, and/or other like devices. In some non-limiting embodiments, acquirer system 110 may be associated with an acquirer, as described herein.

Communication network 112 may include one or more wired and/or wireless networks. For example, communication network 112 may include a cellular network (e.g., a long-term evolution (LTE) network, a third generation (3G) network, a fourth generation (4G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

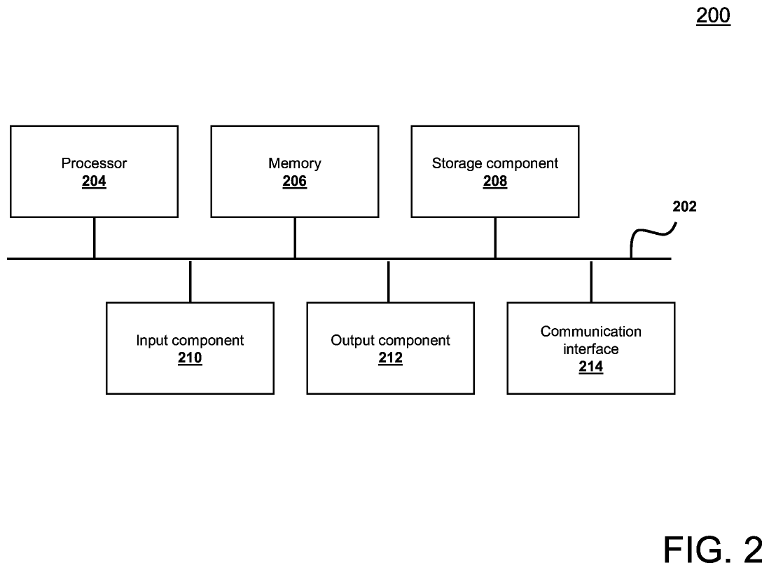

Referring now to FIG. 2, FIG. 2 is a diagram of example components of a device 200. Device 200 may correspond to transaction service provider system 102, and/or one or more devices of issuer system 104, user device 106, and/or merchant system 108. In some non-limiting embodiments, transaction service provider system 102, issuer system 104, user device 106, and/or merchant system 108 may include at least one device 200 and/or at least one component of device 200. As shown in FIG. 2, device 200 may include a bus 202, a processor 204, memory 206, a storage component 208, an input component 210, an output component 212, and a communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

According to non-limiting embodiments, a process for monitoring and improving data quality is disclosed. In some non-limiting embodiments, one or more of the steps of the process may be performed (e.g., completely, partially, etc.) by transaction service provider system 102 (e.g., one or more devices of transaction service provider system 102). In some non-limiting embodiments, one or more of the steps of the process may be performed (e.g., completely, partially, etc.) by another device or a group of devices separate from or including transaction service provider system 102, such as issuer system 104 (e.g., one or more devices of issuer system 104), user device 106, or merchant system 108 (e.g., one or more devices of merchant system 108).

In some non-limiting embodiments, process includes receiving transaction data associated with a plurality of payment transactions. For example, transaction service provider system 102 may receive transaction data (e.g., historical transaction data, first transaction data, first historical transaction data, and/or the like) associated with a plurality of payment transactions involving (e.g., conducted by) a user, a plurality of users, and/or the like. In some non-limiting embodiments, the transaction data may be associated with a plurality of payment transactions involving one or more accounts (e.g., a credit card account, a debit card account, and/or the like) of a user, a plurality of accounts of a plurality of users, and/or the like.

In some non-limiting embodiments, transaction service provider system 102 may receive transaction data associated with a plurality of payment transactions conducted within a predetermined time interval of (e.g., within a predetermined time interval of 30 days from, and/or the like) activation of an account (e.g., a debit account, a credit account, a debit card account, a credit card account, and/or the like) involved in the plurality of payment transactions. For example, transaction service provider system 102 may receive the transaction data associated with the plurality of payment transactions conducted within the predetermined time interval of activation of the account (e.g., a debit account, a credit account, a debit card account, a credit card account, and/or the like) where the plurality of payment transactions involves a user associated with the account.

In some non-limiting embodiments, transaction service provider system 102 may receive the transaction data from issuer system 104 and/or merchant system 108 (e.g., via communications network 112). For example, transaction service provider system 102 may receive the transaction data from merchant system 108 via communications network 112 in real-time while a payment transaction is being conducted, after a payment transaction has been authorized, after a payment transaction has been cleared, and/or after a payment transaction has been settled. In some non-limiting embodiments, historical transaction data may include transaction data associated with one or more payment transactions that have been authorized, cleared, and/or settled.

In some non-limiting embodiments, the transaction data may be associated with a payment transaction (e.g., a payment transaction of a plurality of payment transactions) and/or a plurality of payment transactions. For example, the transaction data may be associated with a payment transaction involving a user and a merchant (e.g., a merchant associated with merchant system 108). In some non-limiting embodiments, the plurality of payment transactions may involve a plurality of users and a plurality of merchants and each payment transaction of the plurality of payment transactions may involve a single user and a single merchant.

In some non-limiting embodiments, the transaction data associated with a payment transaction may include transaction amount data associated with an amount of the payment transaction (e.g., a cost associated with the payment transaction, a transaction amount, an overall transaction amount, a cost of one or more products involved in the payment transaction, and/or the like), transaction time data associated with a time interval at which the payment transaction occurred (e.g., a time of day, a day of the week, a day of a month, a month of a year, a predetermined time of day segment such as morning, afternoon, evening, night, and/or the like, a predetermined day of the week segment such as weekday, weekend, and/or the like, a predetermined segment of a year such as first quarter, second quarter, and/or the like), transaction type data associated with a transaction type of the payment transaction (e.g., an online transaction, a card present transaction, a face-to-face transaction, and/or the like), and/or the like.

Additionally or alternatively, the transaction data may include user transaction data associated with the user involved in the payment transaction, merchant transaction data associated with the merchant involved in the payment transaction, and/or issuer institution transaction data associated with an issuer institution of an account involved in the payment transaction. In some embodiments, user transaction data may include user identity data associated with an identity of the user (e.g., a unique identifier of the user, a name of the user, and/or the like), user account data associated with an account of the user (e.g., an account identifier associated with the user, a PAN associated with a credit and/or debit account of the user, a token associated with a credit and/or debit account of the user, and/or the like), and/or the like.

In some embodiments, merchant transaction data may include merchant identity data associated with an identity of the merchant (e.g., a unique identifier of the merchant, a name of the merchant, and/or the like), merchant category data associated with at least one merchant category of the merchant (e.g., a code for a merchant category, a name of a merchant category, a type of a merchant category, and/or the like), merchant account data associated with an account of the merchant (e.g., an account identifier associated with an account of the merchant, a PAN associated with an account of the merchant, a token associated with an account of the merchant, and/or the like), and/or the like.

In some embodiments, issuer institution transaction data may include issuer institution identity data associated with the issuer institution that issued an account involved in the payment transaction (e.g., a unique identifier of the issuer institution, a name of the issuer institution, an issuer identification number (I I N) associated with the issuer institution, a BIN associated with the issuer institution, and/or the like), and/or the like.

In some non-limiting embodiments, transaction data associated with a payment transaction (e.g., each payment transaction of a plurality of payment transactions) may identify a merchant category of a merchant involved in the payment transaction. For example, transaction data associated with the payment transaction may include merchant transaction data that identifies a merchant category of a merchant involved in the payment transaction. A merchant category may be information that is used to classify the merchant based on the type of goods or services the merchant provides. In some non-limiting embodiments, a payment transaction may involve a merchant that is associated with a merchant category of a plurality of merchant categories.

In some non-limiting embodiments, transaction data associated with a payment transaction may identify a time (e.g., a time of day, a day, a week, a month, a year, a predetermined time interval, and/or the like) at which the payment transaction occurred. For example, the transaction data associated with the payment transaction may include transaction time data that identifies a time interval at which the payment transaction occurred.

In some non-limiting embodiments, transaction service provider system 102 may conduct data pre-processing on transaction data associated with a plurality of payment transactions received from an acquirer system (e.g., an acquirer associated with an acquirer system), determine feature values associated with a textual data field in each transaction record of a plurality of transaction records included in the transaction data associated with the plurality of payment transactions, where the feature values are used in a parsing layer of a natural language processing (NLP) model after conducting data pre-processing on the transaction data associated with the plurality of payment transactions, determine whether the feature values associated with the textual data field satisfy one or more rules associated with the parsing layer of the NLP model, and/or determine a data quality score for each textual data field of each transaction records of the plurality of transaction records included in the transaction data based on determining whether the feature values associated with the textual data fields satisfy one or more rules associated with the parsing layer of the NLP model.

In some non-limiting embodiments, conducting the data pre-processing includes performing a text cleaning process on textual data located in a first textual data field of a first transaction record to produce cleaned textual data and storing a value that includes the cleaned textual data in a first modified textual data field associated with the first transaction record.

In some non-limiting embodiments, conducting the data pre-processing includes extracting a root of a word that is included in textual data located in a first textual data field of a first transaction record and storing a value that includes the root of the word in a first modified textual data field associated with the first transaction record.

In some non-limiting embodiments, the process includes determining whether textual data located in a first textual data field of a first transaction record corresponds to a specified stop-word, determining a lowest value of a data quality score for the textual data located in the first textual data field based on determining that the textual data located in the first textual data field of the first transaction record corresponds to the specified stop-word, and assigning the lowest value of the data quality score to the textual data located in the first textual data field.

In some non-limiting embodiments, the process includes determining whether textual data located in a first textual data field of a first transaction record corresponds to a historical textual description and determining a data quality score for the textual data located in the first textual data field based on determining that the textual data located in the first textual data field of the first transaction record corresponds to the historical textual description.

In some non-limiting embodiments, determining the data quality score for the textual data located in the first textual data field includes determining the data quality score for the textual data located in the first textual data field based on a level of correspondence between the textual data located in the first textual data field of the first transaction record and the historical textual description.

In some non-limiting embodiments, the process includes determining feature values associated with a textual data field in each transaction record of a plurality of transaction records included in the transaction data associated with the plurality of payment transactions. In some non-limiting embodiments, the feature values are used in a parsing layer of a natural language processing (NLP) model after conducting data pre-processing on the transaction data associated with the plurality of payment transactions.

In some non-limiting embodiments, performing the text cleaning process includes changing upper case characters to lower case characters in the textual data located in the first textual data field of the first transaction record and removing specified characters from the textual data located in the first textual data field of the first transaction record. In some non-limiting embodiments, the specified characters include at least one of the following: a number character, an empty character space, a hash code character, a punctuation character, or any combination thereof.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A computer-implemented method for monitoring and improving data quality of transaction data, comprising:
conducting, with at least one processor, data pre-processing on transaction data associated with a plurality of payment transactions received from an acquirer;
determining, with at least one processor, feature values associated with a textual data field in each transaction record of a plurality of transaction records included in the transaction data associated with the plurality of payment transactions, wherein the feature values are used in a parsing layer of a natural language processing (NLP) model after conducting data pre-processing on the transaction data associated with the plurality of payment transactions;
determining, with at least one processor, whether the feature values associated with the textual data field satisfy one or more rules associated with the parsing layer of the NLP model; and
determining, with at least one processor, a data quality score for each textual data field of each transaction record of the plurality of transaction records included in the transaction data based on determining whether the feature values associated with the textual data fields satisfy the one or more rules associated with the parsing layer of the NLP model.

2. The computer-implemented method of claim 1, wherein conducting the data pre-processing comprises:
performing a text cleaning process on textual data located in a first textual data field of a first transaction record to produce cleaned textual data; and
storing a value that includes the cleaned textual data in a first modified textual data field associated with the first transaction record.

3. The computer-implemented method of claim 2, wherein performing the text cleaning process comprises:
changing upper case characters to lower case characters in the textual data located in the first textual data field of the first transaction record;
removing specified characters from the textual data located in the first textual data field of the first transaction record; and
wherein the specified characters include at least one of the following:
a number character,
an empty character space,
a hash code character,
a punctuation character, or
any combination thereof.

4. The computer-implemented method of claim 1, wherein conducting the data pre-processing comprises:
extracting a root of a word that is included in textual data located in a first textual data field of a first transaction record; and
storing a value that includes the root of the word in a first modified textual data field associated with the first transaction record.

5. The computer-implemented method of claim 1, further comprising:
determining whether textual data located in a first textual data field of a first transaction record corresponds to a specified stop-word;
determining a lowest value of a data quality score for the textual data located in the first textual data field based on determining that the textual data located in the first textual data field of the first transaction record corresponds to the specified stop-word; and
assigning the lowest value of the data quality score to the textual data located in the first textual data field.

6. The computer-implemented method of claim 1, further comprising:
determining whether textual data located in a first textual data field of a first transaction record corresponds to a historical textual description; and
determining a data quality score for the textual data located in the first textual data field based on determining that the textual data located in the first textual data field of the first transaction record corresponds to the historical textual description.

7. The computer-implemented method of claim 6, wherein determining the data quality score for the textual data located in the first textual data field comprises:
determining the data quality score for the textual data located in the first textual data field based on a level of correspondence between the textual data located in the first textual data field of the first transaction record and the historical textual description.

8. A system for monitoring and improving data quality of transaction data, comprising:
at least one processor programmed or configured to:
conduct data pre-processing on transaction data associated with a plurality of payment transactions received from an acquirer;
determine feature values associated with a textual data field in each transaction record of a plurality of transaction records included in the transaction data associated with the plurality of payment transactions, wherein the feature values are used in a parsing layer of a natural language processing (NLP) model after conducting data pre-processing on the transaction data associated with the plurality of payment transactions;
determine whether the feature values associated with the textual data field satisfy one or more rules associated with the parsing layer of the NLP model;
determine a data quality score for each textual data field of each transaction record of the plurality of transaction records included in the transaction data based on determining whether the feature values associated with the textual data fields satisfy the one or more rules associated with the parsing layer of the NLP model
determine whether textual data located in a first textual data field of a first transaction record included in the plurality of transaction records corresponds to a specified stop-word;
determine a lowest value of a data quality score for the textual data located in the first textual data field based on determining that the textual data located in the first textual data field of the first transaction record corresponds to the specified stop-word; and
assign the lowest value of the data quality score to the textual data located in the first textual data field.

9. The system of claim 8, wherein, when conducting the data pre-processing, the at least one processor is programmed or configured to:
perform a text cleaning process on textual data located in a first textual data field of a first transaction record to produce cleaned textual data; and
store a value that includes the cleaned textual data in a first modified textual data field associated with the first transaction record.

10. The system of claim 9, wherein, when performing the text cleaning process, the at least one processor is programmed or configured to:
change upper case characters to lower case characters in the textual data located in the first textual data field of the first transaction record; and
remove specified characters from the textual data located in the first textual data field of the first transaction record;
wherein the specified characters include at least one of the following:
a number character,
an empty character space,
a hash code character,
a punctuation character, or
any combination thereof.

11. The system of claim 8, wherein, when conducting the data pre-processing, the at least one processor is programmed or configured to:
extract a root of a word that is included in textual data located in a first textual data field of a first transaction record; and
store a value that includes the root of the word in a first modified textual data field associated with the first transaction record.

12. The system of claim 8, wherein the at least one processor is further programmed or configured to:
determine whether textual data located in a first textual data field of a first transaction record corresponds to a historical textual description; and
determine a data quality score for the textual data located in the first textual data field based on determining that the textual data located in the first textual data field of the first transaction record corresponds to the historical textual description.

13. The system of claim 12, wherein, when determining the data quality score for the textual data located in the first textual data field, the at least one processor is programmed or configured to:
determine the data quality score for the textual data located in the first textual data field based on a level of correspondence between the textual data located in the first textual data field of the first transaction record and the historical textual description.

14. A computer program product for monitoring and improving data quality of transaction data, comprising at least one non-transitory computer-readable medium including one or more instructions that, when executed by at least one processor, cause the at least one processor to:
conduct data pre-processing on transaction data associated with a plurality of payment transactions received from an acquirer;
determine feature values associated with a textual data field in each transaction record of a plurality of transaction records included in the transaction data associated with the plurality of payment transactions, wherein the feature values are used in a parsing layer of a natural language processing (NLP) model after conducting data pre-processing on the transaction data associated with the plurality of payment transactions;
determine whether the feature values associated with the textual data field satisfy one or more rules associated with the parsing layer of the NLP model; and
determine a data quality score for each textual data field of each transaction record of the plurality of transaction records included in the transaction data based on determining whether the feature values associated with the textual data fields satisfy the one or more rules associated with the parsing layer of the NLP model.

15. The computer program product of claim 14, wherein the one or more instructions that cause the at least one processor to conduct the data pre-processing cause the at least one processor to:
perform a text cleaning process on textual data located in a first textual data field of a first transaction record to produce cleaned textual data; and
store a value that includes the cleaned textual data in a first modified textual data field associated with the first transaction record.

16. The computer program product of claim 15, wherein the one or more instructions that cause the at least one processor to perform the text cleaning process cause the at least one processor to:
change upper case characters to lower case characters in the textual data located in the first textual data field of the first transaction record; and
remove specified characters from the textual data located in the first textual data field of the first transaction record;
wherein the specified characters include at least one of the following:
a number character,
an empty character space,
a hash code character,
a punctuation character, or
any combination thereof.

17. The computer program product of claim 14, wherein the one or more instructions that cause the at least one processor to conduct the data pre-processing cause the at least one processor to:
extract a root of a word that is included in textual data located in a first textual data field of a first transaction record; and
store a value that includes the root of the word in a first modified textual data field associated with the first transaction record.

18. The computer program product of claim 14, wherein the one or more instructions further cause the at least one processor to:
determine whether textual data located in a first textual data field of a first transaction record corresponds to a specified stop-word;
determine a lowest value of a data quality score for the textual data located in the first textual data field based on determining that the textual data located in the first textual data field of the first transaction record corresponds to the specified stop-word; and
assign the lowest value of the data quality score to the textual data located in the first textual data field.

19. The computer program product of claim 14, wherein the one or more instructions further cause the at least one processor to:
determine whether textual data located in a first textual data field of a first transaction record corresponds to a historical textual description; and
determine a data quality score for the textual data located in the first textual data field based on determining that the textual data located in the first textual data field of the first transaction record corresponds to the historical textual description.

20. The computer program product of claim 19, wherein the one or more instructions that cause the at least one processor to determine the data quality score for the textual data located in the first textual data field cause the at least one processor to:
determine the data quality score for the textual data located in the first textual data field based on a level of correspondence between the textual data located in the first textual data field of the first transaction record and the historical textual description.
